(19) United States
(12) Patent Application Publication
(10) Pub. No.: US 2008/0044653 A1
(43) Pub. Date: Feb. 21, 2008

(54) Method of Analysing Fibres and Article Necessary Therefor

(76) Inventor: Ana Luiza MELO DE BARROS, (US)

Correspondence Address: EDWIN A. SISSON , ATTORNEY AT LAW , LLC, P. O. BOX 603, SHARON CENTER, OH, 44256, US

(21) Appl. No.: 11/763,612

(22) Filed: Jun. 15, 2007

(30) Foreign Application Priority Data
Jun. 28, 2006 (BR) PI 0602927

(51) Int. Cl. D02G 3/00; G01J 3/46

(52) U.S. Cl. 428/364; 356/402

(57) ABSTRACT

A method of analysing the dye affinity of fibers comprising the steps of Dyeing the fibers, Carding the fibers, Aligning the fibers, Pressing the carded and aligned fibers with a force for a period time and analyzing the color spectra of the pressed fibers is disclosed as well as the pressed fiber article comprised of pressed carded fibers, wherein the fibers are aligned parallel to each other running across the largest surface of the sample.

### PRIORITIES AND CROSS REFERENCES

This application claims priority from foreign filed application No. PI0602927 filed in Brazil on Jun. 28, 2006.

### FIELD OF THE INVENTION

This invention relates to a method of preparing a sample for accurately quantifying the color of polyester fiber samples relative to a control and the article necessary to conduct such analysis.

### BACKGROUND OF THE INVENTION

Many fibers are dyed in order for them to be of commercial utility. The crucial commercial skill is not the ability to dye any individual lot of fibers, but to insure that each lot is colored, or dyed, to the visual level, as the previous lot. Variability in dyeing renders large amounts of fibers unusable or reduces their value. Variability in dyeing is caused by many factors, including, but not limited to, variability in the fiber, the dye mix, or the dyeing process parameters.

The fibers, for example, may contain varying amounts of comonomers, may have variable thicknesses and varying levels of crystallinity; all of which affect the ability of the fiber to absorb the dye.

The dyes for example, may not be consistently blended or have inherent variability as provided by the supplier.

The dyeing process is generally a function of pressure and temperature. These parameters are set in the HT (high temperature) equipment and the fiber lot removed at a predetermined time. If the independent parameters vary, then the wrong amount of dye will have been absorbed in the set period of time. The fiber manufacturer will expend considerable amount of time and resources ensuring that the fiber lots are consistently colored from one lot to the next. To maintain a consistent color from lot to lot, the fiber manufacturers use different color control techniques.

In many color control techniques, samples of fibers are dyed and then visually matched to a control. In one technique, samples of the fibers are removed during the dyeing process and the dyeing process stopped when the lot matches the color of the control. In this technique, the control may be dyed with the lot or the dyed lot compared to an already dyed control.

In another technique, the samples are first dyed, compared to the control, and then the lot is either accepted or discarded.

The common element of these techniques is the comparison to the control (pattern) and the subsequent measurement. In most cases, the comparison is done visually in a light box. While the human eye can often determine a color match, it cannot quantitatively determine the closeness to the match. Therefore, some manufacturers have adopted a rating scale ranging from −2 to +2. A fiber lot rated −2 is unacceptable, not having enough color compared to the control. A rating of −1 still does not have enough color but is acceptable. A rating of 0 is an “exact”0 match of the dyed fiber lot with the control. A rating of +1 has more color than the control but is acceptable; while a fiber lot with a rating of +2 is unacceptable, having too much color.

The use of instruments to read the color has been hindered because the surface effects of the fibers distort the readings. There exists therefore, the need for a method to reduce the surface affects of the fibers so that color comparisons can be done instrumentally.

### SUMMARY

Disclosed in this specification is a color analysis sample comprised of pressed carded fibers, wherein the fibers are aligned parallel to each other running across the largest surface of the sample. It is further disclosed that the fibers comprise polyester. It is also disclosed that the sample has been pressed for at least 5 seconds using a force of at least 25 kN. The sample can also be pressed for at least 10 seconds using a force of at least 50 kN or for at least 15 seconds using a force of at least 100 kN.

Also disclosed is a a method of analysing fibers comprising the steps of carding the fibers, aligning the fibers, pressing the carded and aligned fibers with a force for a period time and analyzing the color spectra of the pressed fibers with an instrument. It is also disclosed that the analyzed fibers comprise polyester. It is also disclosed that the fibers be pressed with a force that is at least 25 kN and the time is at least 30 seconds or a force of at least 50 kN and the time is at least 20 seconds or the force is at least 100 KN and the time is at least 15 seconds.

### DETAILED DESCRIPTION OF THE INVENTION

It has been discovered that the instrumental readings can be very consistent when the fibers are carded, that is rolled upon an axis so that the fibers are substaintally parallel, and then pressed with a predetermined force for an established period of time. After preparing the dyed fiber sample in this manner, the sample can be read instrumentally with improvements over the visual inspection of the same sample.

Outlined below is the procedure used to replace the visual inspection method.

In both, visual and instrumental method, the fibers are homogenized (mixed) and carded. Any standard technique for homogenization may be used. A common practice is to homogenize the fiber sample by dividing it into some aliquoted parts (usually four), homogenize each part, then homogenize the parts with each other again.

The homogenized fibers are then carded until they are substantially free of chips, fuzz, and other surface distorting defects and are substantially aligned, parallel, with each other. Carding is term of art readily known to one of ordinary skill in the fiber industry and any of the many carding techniques may be used.

The following process is the usual dyeing process and the one used in the samples of this specification. Prior to dyeing, the carded fibers underwent preparation to remove spinning finish left from the fiber manufacturing operation. 10 grams of the carded sample were placed into a porous bag made which allowed the dyestuff and chemicals to pass through it, but is itself inert to the dyestuff. In the case of polyester fibers, a cotton bag was used.

The bags were then moistened with de-mineralized water and placed in the dyeing equipment, with high temperature dyeing equipment (HT equipment) preferred for polyester. The control sample, and in some cases, two or more control samples, were placed in the dyeing equipment with the fiber sample to be evaluated.

The material was first purged of de-mineralized water using, for example, a solution containing 10% by volume of Leonil (a mixture of anionic and non anionic surfactant, from Clariant Corporation), 20% of concentration Sodium Carbonate and 10% by volume Sandozin (a mixture of akyl poliglycol ether˜80% and diethilenoglycol monobutyl ether˜4%, from Clariant Corporation).

The following amounts were used for 9.4 L of water (and to dye 250 g of fiber in the HT equipment):

| | |
|---|---|
| Leonil | 9.4 ml |
| Sodium Carbonate | 18.8 ml of a solution of 10% concentration |
| Sandozin | 9.4 ml |

The purging was done by heating the solution containing the samples to 80° C. at a rate of 9° C./minute, mantaining the temperature at 80° C. for 20 minutes and then cooling the solution to 60° C. at a rate of 9° C./minute. The purge solution was then removed from the tank.

The samples were then washed with 9.4 L of water and 9.4 ml of a solution of 3% of concentration (v/v) of acetic acid. After the washing step the wash solution is drained by the equipment.

The samples were then dyed. Each dye supplier and fiber manufacturer will have their own recommendations. In these experiments, 9.4 ml of 1% Ammonium Sulfate, 250 ml of 1% Lyogen (that is an alkylpolyglycolether, which is used as a levelling agent for dyeing polyester fibres, from Clariant Corporation), and 37.5 ml of 0.15% Azul Marinho Foron S, the actual dye from Clariant Corporation, (supplier: Clariant, this is an azo dye).

After washing, the Ammonium Sulfate and Lyogen were added and the pH of the solution have to be checked and adjusted to 5.5 to 6.0 by either adding AcOH or caustic soda (Sodium Hydroxide).

After the proper pH was achieved, the dye, in this case Azul Marinho Foron S, was added. The temperature of the dye medium was increased to 130° C. at a rate of 1° C./minute, maintained at 130° C. for 60 minutes and then cooled to 80° C. at a rate of 3° C./minute. At this point the liquid was drained from the tank, leaving the bags containing the fiber samples.

After dyeing, the excess of the dye was removed in the reduction step. In these examples, the excess dye was removed by adding a reducing solution containing 37.6 ml of 47% of concentration of NaOH and 18.8 ml of 10% of concentration of sodium hydrosulfite.

The reducing solution was heated to 70° C. at a rate of 3° C./minute and maintained at 70° C. for 20 minutes. The dyeing vessel was then drained of the reducing solution and the bags removed. The bags were then centrifuged to remove excess solution and dried in an oven for 10 minutes at 100° C.

The fibers were then carded into a steel wool shape. The carding was preceded by spraying a spinning finish. The carding was done along an axis so that the fibers are aligned in the same direction.

A pre-determined weight of the fiber was removed from the carded sample and then pressed for a pre-determined amount of force and time. In the case of fibers of this example, 2.0 grams of the 1.1-1.5 denier fibers were pressed at 100 kN force for 15 seconds. The 2.0 grams is not an essential number, the 2 grams is based upon the amount needed to create a disk large enough to cover the window of the spectrophotometer. The amount of fiber, amount of force, and amount of time will be specific to the fiber characteristics, such as type, denier and composition.

The proper pressing force and pressing time can easily be determined without undue experimentation. One merely take the portions of the dyed, carded fiber sample and presses them at various pressures for different times until the standard deviation of the instrument measurements reaches a level acceptable to practitioner.

The pressed disks are then analyzed in a spectrophotomer. It is preferable that three disks be analyzed for each sample and each disk analyzed 4 times rotating the disk 90° after each measurement.

In practice, the samples are analyzed for the well known color attributes like: color strength (that is the main color match), color b* and delta E. Percent color strength is the comparison of the intensity of the color between the pattern and a sample, measured in a spectrophotometer by Datacolor. This percentage indicates how lighter or darker the sample is in relation to the reference. If the color strength of the sample is 100% it is equal to the reference, if it is lower than 100%, it is lighter than the reference and it is greater than 100% it is darker than the reference.

Delta E is the distance between the two points in the geometric space of colors. For definition: ΔE=(ΔL²+Δa²+Δb²)^{-/2}, Where L, a, b are the Hunter color coordinates in a space geometric L*, a*, b*.

To demonstrate the superiority of carding and pressuring the sample, 10 samples from one lot of dyed fiber were instrumentally analyzed for full color, delta E and cor b* along various stages of the analysis. The superiority is easily demonstrated by the lower standard deviation of the carded and carded/pressed samples. The average standard deviation amongst the samples for the full color was 0.66 vs 3.31 and 0.10 vs 0.38 for the Delta E.

TABLE I
STANDARD DEVIATION OF SAMPLES

| | Full Color | | | Delta E | | | Cor b* | | |
|---|---|---|---|---|---|---|---|---|---|
| | Non- | | Carded & | Non- | | Carded & | Non- | | Carded & |
| | Carded | Carded | Pressed | Carded | Carded | Pressed | Carded | Carded | Pressed |
| 1 | 4.90 | 0.48 | 1.07 | 0.71 | 0.11 | 0.13 | 0.32 | 0.097 | 0.051 |
| 2 | 2.20 | 0.91 | 0.44 | 0.34 | 0.07 | 0.06 | 0.18 | 0.097 | 0.061 |
| 3 | 4.17 | 0.79 | 0.18 | 0.44 | 0.08 | 0.06 | 0.27 | 0.032 | 0.075 |
| 4 | 2.24 | 1.54 | 0.83 | 0.21 | 0.25 | 0.11 | 0.18 | 0.006 | 0.096 |
| 5 | 2.97 | 2.08 | 0.90 | 0.25 | 0.30 | 0.08 | 0.13 | 0.065 | 0.089 |
| 6 | 2.53 | 0.55 | 0.62 | 0.38 | 0.08 | 0.10 | 0.21 | 0.015 | 0.062 |
| 7 | 5.36 | 0.46 | 0.27 | 0.49 | 0.10 | 0.04 | 0.32 | 0.025 | 0.045 |
| 8 | 2.61 | 0.95 | 0.66 | 0.23 | 0.14 | 0.18 | 0.07 | 0.010 | 0.200 |
| 9 | 3.83 | 0.26 | 0.99 | 0.40 | 0.05 | 0.12 | 0.19 | 0.038 | 0.101 |
| 10 | 2.28 | 2.28 | 1.12 | 0.61 | 0.31 | 0.13 | 0.12 | 0.10 | 0.035 |
| Avg | 3.31 | 0.91 | 0.66 | 0.38 | 0.13 | 0.10 | 0.20 | 0.042 | 0.093 |

What is claimed is:

1. A color analysis sample comprised of pressed carded fibers, wherein the fibers are aligned substantially parallel to each other running across the largest surface of the sample.

2. The color analysis sample of claim 1, wherein the fibers comprise polyester.

3. The color analysis sample of claim 1, wherein the sample has been pressed for at least 5 seconds using a force of at least 25 kN.

4. The color analysis sample of claim 3, wherein the fibers comprise polyester.

5. The color analysis sample of claim 1, wherein the the sample has been pressed for at least 10 seconds using a force of at least 50 kN.

6. The color analysis sample of claim 5, wherein the fibers comprise polyester.

7. The color analysis sample of claim 1, wherein the the sample has been pressed for at least 15 seconds using a force of at least 100 kN.

8. The color analysis sample of claim 7, wherein the fibers comprise polyester.

9. A method of analysing fibers comprising the steps of
Carding the fibers,
Aligning the fibers,
Pressing the carded and aligned fibers with a force for a period time and analyzing the color spectra of the pressed fibers.

10. The method of claim 9, wherein the fibers comprise polyester.

11. The method of claim 9, wherein the force is at least 25 kN and the time is at least 30 seconds.

12. The method of claim 9, wherein the force is at least 50 kN and the time is at least 20 seconds.

13. The method of claim 9, wherein the force is at least 100 KN and the time is at least 15 seconds.
